(19) United States
(12) Patent Application Publication
(10) Pub. No.: US 2022/0303497 A1
(43) Pub. Date: Sep. 22, 2022

(54) ELECTRONIC DEVICE AND SIGNAL PROCESSING METHOD

(71) Applicants: ShenZhen Hongfei Precision Technology Co.,Ltd., Shenzhen (CN); Hon Hai Precision Industry Co., Ltd., New Taipei (TW)

(72) Inventors: YI-HSIANG KAO, New Taipei (TW); WEN-PIN WANG, New Taipei (TW)

(21) Appl. No.: 17/697,177

(22) Filed: Mar. 17, 2022

(30) Foreign Application Priority Data
Mar. 19, 2021 (CN) 202110295195.7

(51) Int. Cl. H04N 7/10; H04N 7/015

(52) U.S. Cl. CPC H04N 7/102; H04N 7/015

(57) ABSTRACT

A method of processing a source signal received from a source device by an electronic device is provided. The electronic device receives the source signal from a source interface of the source device at a signal interface of the electronic device. The signal interface includes a plurality of signal pins. The electronic device detects at least one specific signal level in a plurality of signal levels of the source signal by at least one first specific signal pin in the plurality of signal pins and determines, based on the at least one specific signal level, whether to switch an operation mode of at least one second specific signal pin in the plurality of signal pins to receive the source signal.

### CROSS-REFERENCE TO RELATED APPLICATION(S)

The present disclosure claims the benefit of and priority to China Patent Application Serial No. 202110295195.7, filed on Mar. 19, 2021 (hereinafter referred to as the “'195 application”). The disclosure of the '195 application is hereby incorporated fully by reference into the present disclosure.

### FIELD

The present disclosure is generally related to signal processing, and more specifically, to techniques for processing a source signal received from a source device by an electronic device.

### BACKGROUND

When an electronic device is connected to another electronic device, it is necessary to consider the compatibility of the two interface types of the two electronic devices. In other words, the two interface types of the two electronic devices may be identical to, or compatible with, each other. For example, the two interface types High-Definition Multimedia Interface (HDMI) and mini HDMI (mini-HDMI) are compatible with each other. Thus, an electronic device that has an HDMI port may be connected to another electronic device that has a mini-HDMI port via a cable that includes both an HDMI port and a mini-HDMI port. However, if the interface types of the two electronic devices are different from, or incompatible with, each other, the connection between the two electronic devices may fail due to different operation modes and different signal levels of the two interface types. Thus, there will be no transmission between the two electronic devices having incompatible interface types.

Therefore, an electronic device needs to have a structure (and may implement a method) to adapt to a plurality of different interface types. Then, when such an electronic device receives a signal from another electronic device having an interface with an incompatible interface type, the electronic device may analyze the signal and select an appropriate method to determine a signal level of the signal for parsing the signal.

### SUMMARY

The present disclosure is directed to a signal processing method for processing a source signal received from a source device by an electronic device and an electronic device for processing a source signal received from a source device.

A first aspect of the present disclosure provides a method of processing a source signal received from a source device by an electronic device. The method comprising receiving the source signal from a source interface of the source device at a signal interface of the electronic device, the signal interface including a plurality of signal pins; detecting at least one specific signal level in a plurality of signal levels of the source signal by at least one first specific signal pin in the plurality of signal pins; and determining, based on the at least one specific signal level, whether to switch an operation mode of at least one second specific signal pin in the plurality of signal pins to receive the source signal.

According to an embodiment of the first aspect, an interface type of the source interface is a first one of a plurality of interface types, and an interface type of the signal interface is a second one of the plurality of interface types.

According to an embodiment of the first aspect, the method further comprises determining the first one of the plurality of interface types based on the at least one specific signal level; switching the operation mode to receive the source signal when the first one of the plurality of interface types is different from the second one of the plurality of interface types; and allowing the operation mode to remain unchanged to receive the source signal when the first one of the plurality of interface types is equal to the second one of the plurality of interface types.

According to an embodiment of the first aspect, the plurality of signal pins receives the source signal according to the second one of the plurality of interface types when the operation mode remains unchanged, and the plurality of signal pins receives the source signal according to the first one of the plurality of interface types when the operation mode is switched.

According to an embodiment of the first aspect, the method further comprises determining the first one of the plurality of interface types based on the at least one specific signal level; and transmitting a control signal to the source device by the signal interface for indicating to the source interface to transmit the source signal according to the second one of the plurality of interface types when the first one of the plurality of interface types is different from the second one of the plurality of interface types.

According to an embodiment of the first aspect, each of the plurality of interface types has a pin distance, and the pin distances of the plurality of interface types are identical to each other.

According to an embodiment of the first aspect, the plurality of interface types includes a High Definition Multimedia Interface (HDMI) and a display port interface (DisplayPort).

According to an embodiment of the first aspect, the method further comprises determining the first one of the plurality of interface types is the DisplayPort when the at least one specific signal level is identical to a ground level; and determining the first one of the plurality of interface types is the HDMI when one of the at least one specific signal level is different from the ground level.

According to an embodiment of the first aspect, the at least one first specific signal pin includes at least one of a thirteenth signal pin, a fourteenth signal pin, a sixteenth signal pin, and a nineteenth signal pin in the plurality of signal pins, and the at least one second specific signal pin includes at least one of the at least one first specific signal pin, a fifteenth signal pin, a seventeenth signal pin, and an eighteenth signal pin.

According to an embodiment of the first aspect, the electronic device is coupled to the source device by a connection device including a first connection interface and a second connection interface, an interface type of the first connection interface is identical to one of the first one and the second one of the plurality of interface types, and an interface type of the second connection interface is identical to one of the first one and the second one of the plurality of interface types.

A second aspect of the present disclosure provides an electronic device for processing a source signal received from a source device. The electronic device comprises a signal interface comprising a plurality of signal pins, the signal interface being configured to receive the source signal from a source interface of the source device when the source device is coupled to the electronic device; a detecting circuit coupled to at least one first specific signal pin of the plurality of signal pins, the detecting circuit being configured to detect at least one specific signal level in a plurality of signal levels of the source signal from the at least one first specific signal pin; and at least one switch, each of the at least one switch being coupled to the detecting circuit and to one of at least one second specific signal pin of the plurality of signal pins to switch an operation mode of the at least one second specific signal pin based on the at least one specific signal level.

According to an embodiment of the second aspect, an interface type of the source interface is a first one of a plurality of interface types, and an interface type of the signal interface is a second one of the plurality of interface types.

According to an embodiment of the second aspect, the operation mode is switched when the first one of the plurality of interface types determined based on the at least one specific signal level is different from the second one of the plurality of interface types, and the operation mode remains unchanged when the first one of the plurality of interface types is equal to the second one of the plurality of interface types.

According to an embodiment of the second aspect, the plurality of signal pins receives the source signal according to the second one of the plurality of interface types when the operation mode remains unchanged, and the plurality of signal pins receives the source signal according to the first one of the plurality of interface types when the operation mode is switched.

According to an embodiment of the second aspect, a control signal is transmitted to the source device by the signal interface for indicating to the source interface to transmit the source signal according to the second one of the plurality of interface types when the first one of the plurality of interface types determined based on the at least one specific signal level is different from the second one of the plurality of interface types.

According to an embodiment of the second aspect, each of the plurality of interface types has a pin distance, and the pin distances of the plurality of interface types are identical to each other.

According to an embodiment of the second aspect, the plurality of interface types includes a High Definition Multimedia Interface (HDMI) and a display port interface (DisplayPort).

According to an embodiment of the second aspect, the electronic device further comprises a power supply device coupled to the signal interface, the power supply device being configured to supply power to the signal interface for the signal interface to receive the source signal according to the HDMI when the first one of the plurality of interface types is the HDMI and the second one of the plurality of interface types is the DisplayPort.

According to an embodiment of the second aspect, the first one of the plurality of interface types is determined as the DisplayPort when the at least one specific signal level is identical to a ground level, and the first one of the plurality of interface types is determined as the HDMI when one of the at least one specific signal level is different from the ground level.

According to an embodiment of the second aspect, the at least one first specific signal pin includes at least one of a thirteenth signal pin, a fourteenth signal pin, a sixteenth signal pin, and a nineteenth signal pin in the plurality of signal pins, and the at least one second specific signal pin includes at least one of the at least one first specific signal pin, a fifteenth signal pin, a seventeenth signal pin, and an eighteenth signal pin.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 illustrates a block diagram of a system configured to transmit and receive a source signal, according to an implementation of the present disclosure.

FIG. 2 illustrates a block diagram of the first interface module, the connection device, and the second interface module illustrated in FIG. 1, according to an implementation of the present disclosure.

FIG. 3 illustrates a circuit diagram of the second interface module illustrated in FIG. 1, according to an implementation of the present disclosure.

FIG. 4 illustrates a flowchart of a method for processing a source signal by the second electronic device illustrated in FIG. 1, according to an implementation of the present disclosure.

### DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, like features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” may refer to one or more of the same or different implementations. The term “coupled” is defined as connected, whether directly or indirectly, through intervening components and is not necessarily limited to physical connections. The term “comprising” means “including, but not necessarily limited to” and specifically indicates open-ended inclusion or membership in the so-described combination, group, series and the equivalent.

For purposes of explanation and non-limitation, specific details such as functional entities, techniques, protocols, and standards are set forth for providing an understanding of the disclosed technology. Detailed disclosure of well-known methods, technologies, systems and architectures are omitted so as not to obscure the present disclosure with unnecessary details.

Persons skilled in the art will recognize that any disclosed coding function(s) or algorithm(s) described in the present disclosure may be implemented by hardware, software or a combination of software and hardware. Disclosed functions may correspond to modules that are software, hardware, firmware, or any combination thereof.

A software implementation may include a program having computer executable instructions stored on computer readable medium such as memory or other type of storage devices. For example, one or more microprocessors or general-purpose computers with communication processing capability may be programmed with executable instructions and perform the disclosed function(s) or algorithm(s).

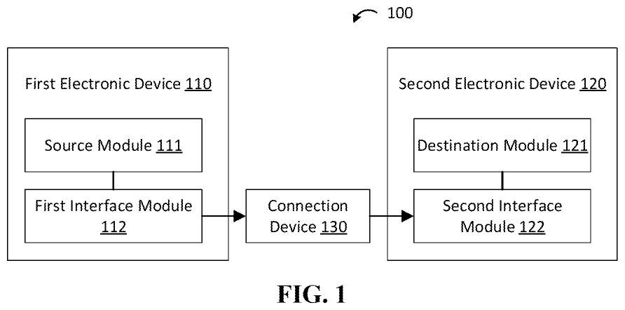

FIG. 1 illustrates a block diagram of a system 100 configured to transmit and receive a source signal, according to an implementation of the present disclosure. The system 100 may include a first electronic device 110, a second electronic device 120, and a connection device 130. The first electronic device 110 may include any devices, units, or modules configured to send a source signal to the connection device 130. The electronic device 120 may include any devices, units, or modules configured to receive the source signal via the connection device 130 from the first electronic device 110. Therefore, the first electronic device 110 may be a signal source device for sending source signals, and the second electronic device 120 may be a signal destination device for receiving the source signals.

The first electronic device 110 may wiredly communicate with the second electronic device 120 via the connection device 130. The first electronic device 110 may include a signal source module 111 and a first interface module 112. The second electronic device 120 may include a signal destination module 121 and a second interface module 122.

The first electronic device 110 and/or the second electronic device 120 may be a mobile phone, a tablet computer, a desktop computer, a notebook computer, a monitor, a television, an electronic whiteboard, a projector, projector, camera, game console or other electronic devices. FIG. 1 only shows an example of the first electronic device 110 and the second electronic device 120. In other implementations, the first electronic device 110 and the second electronic device 120 may include more or fewer elements than the first electronic device 110 and the second electronic device 120 shown in FIG. 1 or have different configurations with various elements.

The signal source module 111 of the first electronic device 110 and the signal destination module 121 of the second electronic device 120 may each be implemented as any of a variety of suitable processing circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware or any combinations thereof. When implemented partially in software, a device may store the program having instructions for the software in a suitable, non-transitory computer-readable medium and execute the instructions in hardware using one or more processors to perform the disclosed methods.

The signal source module 111 of the first electronic device 110 may include a data capture device (not shown) to capture new data, a data archive to store previously captured data, and/or a video feed interface (not shown) to receive data from a data content provider. The data may be any form of data, such as text data, symbol data, image data, audio data, and video data. If the data is image data or video data, the signal source module 111 of the first electronic device 110 may generate computer graphics-based data as the source video or generate a combination of live video, archived video, and computer-generated video as the source video. The data capture device may be a charge-coupled device (CCD) image sensor, a complementary metal-oxide-semiconductor (CMOS) image sensor, or a camera. The data may be transmitted by generating the source signal through the signal source module 111.

The signal destination module 121 of the second electronic device 120 may include a display using liquid crystal display (LCD) technology, plasma display technology, organic light emitting diode (OLED) display technology, or light emitting polymer display (LPD) technology, with other display technologies used in other implementations. The signal destination module 121 may include a high-definition display or an ultra-high-definition display.

The first interface module 112 and the second interface module 122 may include a computer system interface that enables signals to be stored on or received by an electronic device. For example, the first interface module 112 and the second interface module 122 may include connectors compatible with one of a plurality of interface types. The plurality of interface types includes High-Definition Multimedia Interface (HDMI), DisplayPort (DP), Peripheral Component Interconnect (PCI) bus protocol, PCI Express (PCIe) bus protocol, Thunderbolt, Universal Serial Bus (USB) protocol, Mobile High-Definition Link (MHL), or other interface technologies for interconnecting peer devices. The first interface module 112 of the first electronic device 110 may include a source interface compatible with a first interface type of the plurality of interface types, and the second interface module 122 of the second electronic device 120 may include a signal interface compatible with a second interface type of the plurality of interface types. In one implementation, the first interface type and the second interface type may be identical to each other. In another implementation, the first interface type and the second interface type may be different from each other.

Two ends of the connection device 130 may be respectively coupled to the first interface module 112 and the second interface module 122, so the two ends of the connection device 130 respectively have a connector compatible with one of the plurality of interface types. The interface type of one end of the connection device 130 may be identical to the first interface type to couple to the first interface module 112, and the interface type of the other end of the connection device 130 may be identical to the second interface type to couple to the second interface module 122. In at least one implementation, when the first interface type and the second interface type are identical to each other, the interface types of the two ends of the connection device 130 are identical to each other. In at least one implementation, when the first interface type and the second interface type are different from each other, the interface types of the two ends of the connection device 130 are different from each other.

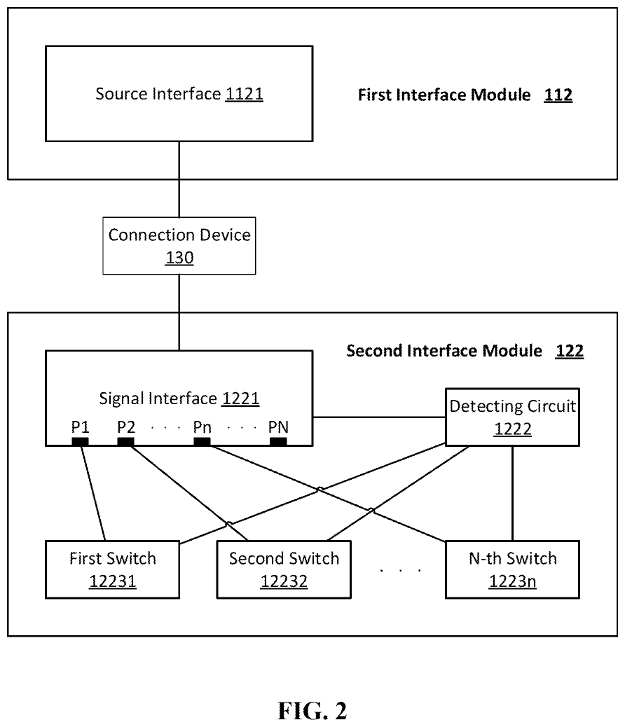

FIG. 2 illustrates a block diagram of the first interface module 112, the connection device 130, and the second interface module 122 illustrated in FIG. 1, according to an implementation of the present disclosure. The first interface module 112 may be coupled to the second interface module 122 via the connection device 130.

The first interface module 112 may include a source interface 1121. The second interface module 122 may include a signal interface 1221, a detecting circuit 1222 and at least one switch. The connection device 130 may be coupled to the source interface 1121 and the signal interface 1221. In at least one implementation, the at least one switch includes a first switch 12231, a second switch 12232, . . . , and an N-th switch 1223n. In at least one implementation, the number N may be a positive integer greater than one.

The signal interface 1221 may receive a source signal from the first interface module 112 of the first electronic device 110 when the second electronic device 120 is coupled to the first electronic device 110 through the connecting device 130. The signal interface 1221 may include a plurality of signal pins P1, P2, . . . , and PN. In at least one implementation, the number N may be a positive integer greater than one.

The plurality of signal pins P1, P2, . . . , and PN may include at least one first specific signal pin. Each of the at least one first specific signal pin may be coupled to the detecting circuit 1222. The plurality of signal pins P1, P2, . . . , and PN may include at least one second specific signal pin. The at least one second specific signal pin may be a plurality of signal pins Pi, Pii, . . . , and Pn in the plurality of signal pins P1, P2, . . . , and PN. Each of the at least one second specific signal pins Pi, Pii, . . . , and Pn may be respectively coupled to different one of the at least one switches 12231, 12232, . . . , and 1223n. The at least one second specific signal pin may include the at least one first specific signal pin. In at least one implementation, when the second interface type of the signal interface 1221 is DP, the number N may be equal to 20. Thus, the plurality of signal pins P1, P2, . . . , and PN may include twenty signal pins P1, P2, . . . , and P20.

Since different interface types may correspond to different interface structures, the second interface type of the second interface module 122 may be determined by the interface structure of the signal interface 1221. The second interface module 122 may couple to the at least one switch 12231, 12232, . . . , and 1223n through the detecting circuit 1222 for receiving the source signal from the source interface 1121 having a different interface type.

In at least one implementations, when the second interface type of the signal interface 1221 is DP, the second interface module 122 may use the combination of the detecting circuit 1222 and the at least one switch 12231, 12232, . . . , and 1223n to receive the source signal from the source interface 1121 having the interface type being one of HDMI and DP. In at least one implementation, when the second interface type of the signal interface 1221 is HDMI, the second interface module 122 may use the combination of the detecting circuit 1222 and the at least one switch 12231, 12232, . . . , and 1223n to receive the source signal from the source interface 1121 having the interface type being one of HDMI and USB.

The second interface module 122 may be preset to have a plurality of compatible interface types, and the detecting circuit 1222 may be used to detect which one of the compatible interface types is identical to the first interface module 112 coupled to the second interface module 122. The detecting circuit 1222 further outputs the detection result to the at least one switch 12231, 12232, . . . , and 1223n. Thus, the second interface module 122 may be switched according to a signal pin difference between the first interface type and the second interface type to cooperate with the first interface type of the first interface module 112 for performing the signal processing. Therefore, when the first interface type detected by the second interface module 122 is identical to the second interface type, the detecting circuit 1222 may output a first detection signal as the detection result. The at least one switch 12231, 12232, . . . , and 1223n may switch the at least one second specific signal pin according to the first detection signal for receiving the source signal. In addition, when the first interface type detected by the second interface module 122 is different from the second interface type, the detecting circuit 1222 may output a second detection signal as the detection result. The at least one switch 12231, 12232, . . . and 1223n may switch the at least one second specific signal pin according to the second detection signal for receiving the source signal.

In at least one implementation, each of the at least one second specific signal pin may be a signal pin having different signal levels between different compatible interface types. In at least one implementation, each of the at least one second specific signal pin may be a signal pin having different functions for different compatible interface types. The at least one first specific signal pin may be selected from the at least one second specific signal pin based on ground level pins in the compatible interface types.

For example, the signal levels of the 12th pin and the 14th pin of the first interface type may be both positive levels, the signal level of the 12th pin of the second interface type may be a negative level, and the signal level of the 14th pin of the second interface type may be a ground level. Thus, the 12th pin and the 14th pin of the signal interface 1221 may be set to be included in the at least one second specific signal pin and respectively coupled to one of the at least one switch for switching based on the first interface type. In addition, the 14th pin of the signal interface 1221 may also be set to be included in the at least one first specific signal pin and coupled to the detecting circuit 1222. Thus, the 14th pin of the signal interface 1221 may determine whether the received signal level is the ground level for determining which one of the compatible interface types is identical to the first interface type.

When the compatible interface types are HDMI and DP, the at least one first specific signal pin may include the 13th pin P13, the 14th pin P14, the 16th pin P16 and the 19th pin P19 selected from the twenty signal pins P1, P2, . . . , and P20. In addition, the at least one second specific signal pin may include the 15th pin P15, the 17th pin P17, and the 18th pin P18 selected from the twenty signal pins P1, P2, . . . , and P20 and further include the at least one first specific signal pin having the 13th pin P13, the 14th pin P14, the 16th pin P16 and the 19th pin P19.

The detecting circuit 1222 may be coupled to the at least one first specific signal pin to detect at least one specific signal level included in a plurality of signal levels of the source signal for generating a detection result based on the at least one specific signal level. The detecting circuit 1222 may be a logic circuit. In at least one implementation, the detecting circuit 1222 may be a NOR logic circuit. When each of the at least one specific signal level detected by the detecting circuit 1222 is a low level or a ground level, the detecting circuit 1222 may output a high-level signal as the detection result.

In addition, when one or more of the at least one specific signal level detected by the detecting circuit 1222 is not a low level or a ground level, the detecting circuit 1222 may output a low-level signal as the detection result. In at least one implementation, the detecting circuit 1222 may be an OR logic circuit. When each of the at least one specific signal level detected by the detecting circuit 1222 is a low level or a ground level, the detecting circuit 1222 may output a low-level signal as the detection result. In addition, when one or more of the at least one specific signal level detected by the detecting circuit 1222 is not a low level or a ground level, the detecting circuit 1222 may output a high-level signal as the detection result.

For example, the second interface type of the signal interface 1221 may be DP and the detecting circuit 1222 may be a NOR logic circuit. When each of the specific signal levels of the 13th pin P13, the 14th pin P14, the 16th pin P16, and the 19th pin P19 detected by the detecting circuit 1222 are the ground level, the detecting circuit 1222 may output the high-level signal as the detection result. When the detecting circuit 1222 determines that one or more of the specific signal levels of the 13th pin P13, the 14th pin P14, the 16th pin P16, and the 19th pin P19 is the high level, the detecting circuit 1222 may output the low-level signal as the detection result.

Each of the at least one switch 12231, 12232, . . . , and 1223n may be coupled to the detecting circuit 1222 and also coupled to different one of the at least one second specific signal pin included in the plurality of signal pins P1, P2, . . . , and PN to determine, based on the detection result, whether to switch the operation mode of the at least one second specific signal pin. Since the number of the at least one second specific signal pin Pi, Pii, . . . , and Pn may be less than or equal to the plurality of signal pins P1, P2, . . . , and PN, the number n may be less than or equal to the number N.

When the number of the plurality of compatible interface types of the second interface module 122 is equal to two, the number of the detecting circuits 1222 coupled to the signal interface 1221 may be equal to one. Thus, the at least one specific signal level of the source signal detected from the at least one first specific signal pin may be used to identify which one of the two compatible interface types is identical to the first interface type of the first interface module 112.

When the number of the plurality of compatible interface types of the second interface module 122 is equal to a number K, the number of the detecting circuits 1222 coupled to the signal interface 1221 may be equal to a number M. Thus, there may be M sets of the at least one switch. In the implementation, the number K may be a positive integer greater than three, and the number M may be a positive integer greater than two. In at least one implementation, the number M may be equal to K−1. For example, when the number of the plurality of compatible interface types of the second interface module 122 is equal to three, the number of the detecting circuits 1222 coupled to the signal interface 1221 may be equal to two. Thus, the number of the sets may be equal to two.

A first one of the detecting circuits 1222 may determine whether the first interface type is identical to a first one of the three compatible interface types. If the detection result is “Yes”, the second interface module 122 may be switched to perform the operation mode determined based on the first compatible interface type by a first set of the switches. If the detection result is “No”, a second one of the detecting circuit 1222 may determine which one of the second and third compatible interface types is identical to the first interface type. Then, the detection result of the second detecting circuit 1222 may be used to switch the second interface module 122 between the second compatible interface type and the third compatible interface type by a second set of the switches.

The plurality of interface types may be separated into two groups including a power transmission interface group and a self-powered interface group based on a power transmission between the two electronic devices. When the second interface type of the signal interface 1221 is included in the power transmission interface group, the first interface module 112 may supply power to the signal interface 1221 through the connection device 130. When the second interface type of the signal interface 1221 is included in the self-powered interface group, the second electronic device 120 may directly supply power to the signal interface 1221. Therefore, when the plurality of compatible interface types includes an interface type included in the power transmission interface group and another interface type included in the self-powered interface group, the signal interface 1221 may be coupled to a power supply device (not shown) of the second electronic device 120. When the source interface 1121 does not supply power to the signal interface 1221, the power supply device of the second electronic device 120 may supply power to the signal interface 1221. In at least one implementation, the power supply device may be coupled to a switch to determine whether the power supply device supplies power to the signal interface 1221.

The connection device 130 may be selected according to the first interface type of the first interface module 112 and the second interface type of the second interface module 122. When both the first interface type and the second interface type are DP, the connectors at both ends of the connection device 130 may be DP connectors. When the first interface type and the second interface type are DP and HDMI, respectively, the connector at one of the two ends of the connection device 130 may be a DP connector and the connector at the other end of the connection device 130 may be an HDMI connector. When the first interface type and the second interface type are USB and HDMI, respectively, the connector at one of the two ends of the connection device 130 may be a USB connector and the connector at the other end of the connection device 130 may be an HDMI connector.

When the first interface module 112 also includes at least one switch, the second interface module 122 may send a control signal of the signal interface 1221 for showing the detection result to the first interface module 112. When the first interface module 112 receives the control signal from the second interface module 122, the first interface module 112 may determine whether to switch at least one second specific signal pin of the source interface 1121 by the at least one switch. Therefore, when the control signal indicates that the second interface type is different from the first interface type, the first interface module 112 may instruct the source interface 1121 to send the source signal according to the second interface type indicated by the control signal. In at least one implementation, the second interface module 122 may have a detecting circuit 1222 and no switch, so that the second interface module 122 may generate the detection result of the detecting circuit 1222 and send the control signal to the first interface module 112 for switching the operation mode of the first interface module 112.

After deducting the at least one second specific signal pin from the plurality of signal pins P1, P2, . . . , and PN, the other signal pins may be regarded as a plurality of remaining pins. Each of the plurality of signal pins P1, P2, . . . , and PN may be coupled to the signal destination module 121 so that the signal destination module 121 may process the source signal. The signal destination module 121 may include a plurality of sub-modules (not shown), and the plurality of sub-modules may be coupled to the plurality of remaining pins and further coupled to the at least one second specific signal pin via at least one output pin of the at least one switch.

The plurality of compatible interface types may have the same pin distance. Thus, the signal interface 1221 may be wired for the plurality of compatible interface types. For example: the pin distances of HDMI and DP are both 0.5 mm (millimeter).

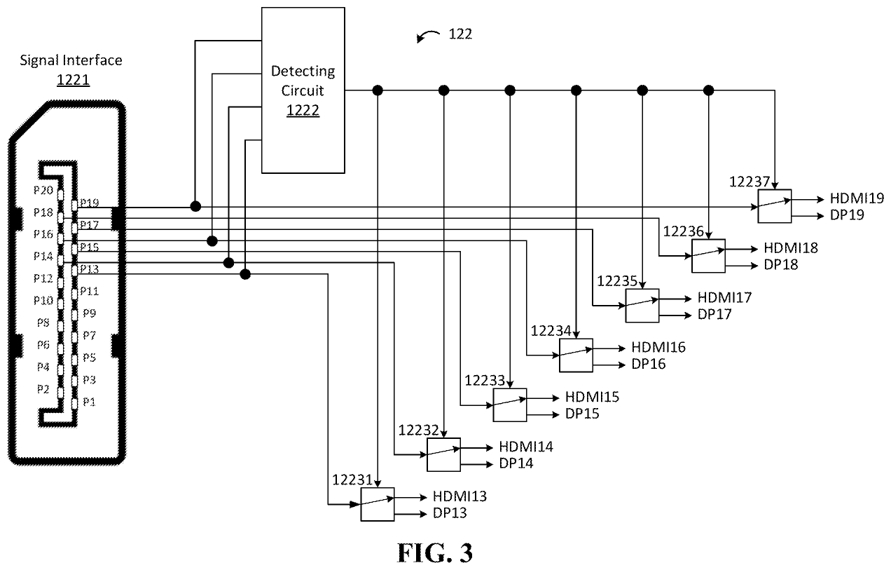

FIG. 3 illustrates a circuit diagram of the second interface module 122 illustrated in FIG. 1, according to an implementation of the present disclosure. In FIG. 3, the compatible interface type may be HDMI and DP and the second interface type of the second interface module 122 may be DP. The second interface module 122 may include a signal interface 1221, a detecting circuit 1222 and seven switches 12231-12237. Since the second interface type is DP, the signal interface 1221 may include twenty signal pins P1-P20. In the signal interface 1221, the 1st, 4th, 7th, and 10th pins (P1, P4, P7, and P10) may be signal pins each receiving a positive signal level, and the 3rd, 6th, 9th, and 12th pins (P3, P6, P9, and P12) may be signal pins each receiving a negative signal level, and the 2nd, 5th, 8th, 11th, 13th, 14th, and 16th pins (P2, P5, P8, P11, P13, P14, and P16) may be signal pins each receiving a ground level. In addition, the 15th, 17th, 18th, 19th, and 20th pins (P15, P17, P18, P19, and P20) are a positive auxiliary channel signal pin, a negative auxiliary channel signal pin, a hot plug signal pin, a return-for-power pin, and a power pin, respectively. In addition, the return-for-power pin P19 for DP may be also a ground level signal pin.

When the first interface type of the source interface 1121 is HDMI, the source interface 1121 may include nineteen signal pins. In the source interface 1121, the 1st, 4th, 7th, and 10th pins of the source interface 1121 are signal pins each receiving a positive signal level, the 3rd, 6th, 9th, and 12th pins of the source interface 1121 are signal pins each receiving a negative signal level, and the 2th, 5th, 8th, 11th, and 17th pins of the source interface 1121 are signal pins each receiving a ground level. In addition, the 13th, 14th, 15th, 16th, 18th, and 20th signal pins are a Consumer Electronics Control (CEC) signal pin, a reserved signal pin, a serial clock (SCL) signal pin, a Serial Data (SDA) signal pin, a power supply signal pin, and a hot plug signal pin, respectively.

After comparing the signal levels between the DP signal pins and the HDMI signal pins, the 13th-19th pins (P13-P19) of the signal interface 1221 may be set as the at least one second specific signal pin, and each coupled to a different one of the seven switches 12231-12237 to switch the operation mode based on the first interface type. In addition, since the 13th, 14th, 16th, and 19th pins (P13, P14, P16, and P19) of the signal interface 1221 are ground level pins and included in the at least one second specific signal pin, the 13th, 14th, 16th, and 19th pins (P13, P14, P16, and P19) of the signal interface 1221 may be further set as the at least one first specific signal pin. Thus, each of the 13th, 14th, 16th, and 19th pins (P13, P14, P16, and P19) of the signal interface 1221 may be coupled to the detecting circuit 1222 to determine which one of the compatible interface type is identical to the first interface type based on the detection result.

The detecting circuit 1222 may be coupled to the 13th, 14th, 16th, and 19th pins (P13, P14, P16, and P19) of the signal interface 1221 to detect four specific signal levels of the signal levels in the source signal from the 13th, 14th, 16th, and 19th pins (P13, P14, P16, and P19). When each of the four specific signal levels is the ground level, the detecting circuit 1222 may output a first detection signal as the detection result, and the first detection signal may represent that the source signal is sent from a DP interface through the connection device 130. Thus, the first interface type may be also DP. When one or more of the four specific signal levels is not the ground level, the detecting circuit 1222 may output a second detection signal as the detection result, the second detection signal may represent that the source signal may be sent from a HDMI interface through the connection device 130. Thus, the first interface type may be HDMI.

The detecting circuit 1222 may be a logic circuit. In at least one implementation, the detecting circuit 1222 may be a NOR logic circuit or an OR logic circuit. When the detecting circuit 1222 is the NOR logic circuit, the first detection signal may be a high-level signal, and the second detection signal may be a low-level signal. When the detecting circuit 1222 is the OR logic circuit, the first detection signal may be a low-level signal and the second detection signal may be a high-level signal.

Each of the seven switches 12231-12237 may be coupled to an output end of the detecting circuit 1222 to receive the detection result of the detecting circuit 1222. The seven switches 12231-12237 may be respectively coupled to one of the 13-19th pins (P13-P19) of the signal interface 1221 to receive the signal levels from the 13-19th pins (P13-P19), respectively. Each of the seven switches 12231-12237 may have two output terminals. One of the output terminals may be a DP output terminal, such as DP13-DP19, and the other output terminal may be an HDMI output terminal, such as HDMI13-HDMI19. The seven switches 12231-12237 may determine whether to switch the operation mode of the 13-19th pins (P13-P19) based on the received detection result. When the seven switches 12231-12237 receive the first detection signal, the first interface type and the second interface type are both DP. Thus, the seven switches 12231-12237 may output via the DP output terminals DP13-DP19. When the seven switches 12231-12237 receive the second detection signal, the first interface type and the second interface type are HDMI and DP, respectively. Thus, the seven switches may output via the HDMI output terminals HDM13-HDMI19.

The seven switches 12231-12237 may be configured to control the 13th-19th pins (P13-P19) to output via the DP output terminals DP13-DP19 when receiving a high-level signal. In addition, the seven switches 12231-12237 may also be configured to control the 13th-19th pins (P13-P19) to output via the HDMI output terminals HDMI13-HDMI19 when receiving a low-level signal. The detecting circuit 1222 may be a NOR logic circuit. Thus, when the seven switches 12231-12237 receive the high-level signal as the first detection signal, the seven switches 12231-12237 may control the output terminals of the switches 12231-12237 to be the DP output terminals DP13-DP19. In addition, when the seven switches 12231-12237 receive the low-level signal as the second detection signal, the seven switches 12231-12237 may control the output terminals of the switches 12231-12237 to be the HDMI output ends HDMI13-HDMI19.

The seven switches 12231-12237 may be configured to control the 13th-19th pins (P13-P19) to output via the DP output terminals DP13-DP19 when receiving the low-level signal. In addition, the seven switches 12231-12237 may also be configured to control the 13th-19th pins (P13-P19) to output via the HDMI output terminals HDMI13-HDMI19 when receiving the high-level signal. The detecting circuit 1222 may be a OR logic circuit. Thus, when the seven switches 12231-12237 receive the low-level signal as the first detection signal, the seven switches 12231-12237 may control the output terminals of the switches 12231-12237 to be the DP output terminals DP13-DP19. In addition, when the seven switches 12231-12237 receive the high-level signal as the second detection signal, the seven switches 12231-12237 may control the output terminals of the switches 12231-12237 to be the HDMI output ends HDMI13-HDMI19.

The 15th pin (SCL) and the 16th pin (SDA) of an HDMI connector may have 5V (volt) voltage. Therefore, when the first interface type is HDMI and the second interface type is DP, in order to prevent the 15th and 16th pins of the signal interface 1221 from receiving the 5V voltage, the seven switches 12231-12237 may be preset to control the 13th-19th pins (P13-P19) to output via the HDMI output terminals HDMI13-HDMI19. In addition, the seven switches 12231-12237 may be configured to control the 13th-19th pins (P13-P19) to output via the DP output terminals DP13-DP19 when receiving the high-level signal.

When the second interface type of the signal interface 1221 is included in the power transmission interface group, the first interface module 112 may supply power to the signal interface 1221 via the connection device 130. When the second interface type of the signal interface 1221 is included in the self-powered interface group, the power supply device in the second electronic device 120 may directly supply power to the signal interface 1221. Therefore, when the first interface type of the source interface 1121 is DP and the second interface type of the signal interface 1221 is HDMI, the source signal of the source interface 1121 may not supply power to the signal interface 12221 because the source signal of the source interface 1121 is transmitted based on the DP interface type. The power supply device of the second electronic device 120 may directly supply power to the signal interface 1221. Thus, the signal interface 1221, which is an HDMI interface type, may still be enabled to receive the source signal based on the DP interface type when the source interface 1121 may not supply power to the signal interface 1221 via the connection device 130. The HDMI interface type may not have a 20th pin to couple to the power supply device. However, when the signal interface 1221 is HDMI, the signal interface 1221 may still be coupled to the power supply device in any form of the connections. When the interface type of the signal interface 1221 is DP, the 20th pin of the signal interface 1221 may be used as one of the at least one second specific signal pin and coupled to one of the at least one switch via the detecting circuit 1222. Thus, the detection result of the detecting circuit 1222 may be used to determine whether the signal interface 1221 needs the power supply device to supply power through the 20th pin.

When the first interface module 112 has at least one switch, the second interface module 122 may send a control signal of the signal interface 1221 to the first interface module 112 for providing the detection result to the first interface module 112. The first interface module 112 may receive the control signal from the second interface module 122 to determine whether to use the at least one switch to switch at least one second specific signal pin of the source interface 1121. For example, when the first interface type is HDMI and the second interface type is DP, the signal interface 1221 may use the 15th and 17th signal pins (e.g., the auxiliary channel signal pins) to transmit the control signal for communicating with the first interface module 112. Thus, the at least one switch in the first interface module 112 may be switched to transmit the source signal based on the DP interface type.

After deducting the at least one second specific signal pin from the plurality of signal pins P1, P2, . . . , and P20, the other signal pins may be regarded as a plurality of remaining pins. Each of the plurality of signal pins P1, P2, . . . , and P20 may be coupled to the signal destination module 121 so that the signal destination module 121 may process the source signal. The signal destination module 121 may include a plurality of sub-modules (not shown), and the plurality of sub-modules may be coupled to the plurality of remaining pins and further coupled to the at least one second specific signal pin via a plurality of output terminals HDMI13-HDMI19 and DP13-DP19 of the at least one switch.

In the present disclosure, due to the design of the detecting circuit 1222 and the at least one switch, the operation mode of the signal interface 1221 of the second electronic device 120 may not be restricted by its own interface structure. Thus, the signal interface 1221 may be able to receive the source signal from a different source interface 1121 having a different compatible interface type. In addition, the operation mode of the signal interface 1221 may be switched to be identical to the operation mode of the source interface 1121 based on the detection result of the detecting circuit 1222.

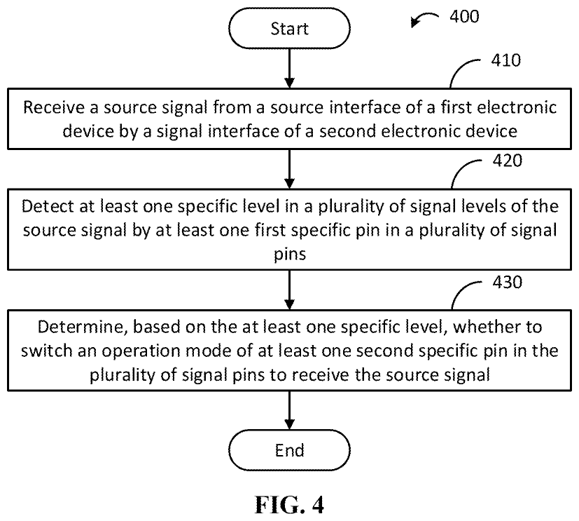

FIG. 4 illustrates a flowchart of a method 400 for processing a source signal by the second electronic device 120 illustrated in FIG. 1, according to an implementation of the present disclosure. The example method is provided by way of example only, as there are a variety of ways to carry out the method.

The method described below may be carried out using the configuration illustrated in FIG. 1, FIG. 2, and/or FIG. 3, for example, and various elements of these figures are referenced in explaining the example method. Each block shown in FIG. 4 represents one or more processes, methods, or subroutines, carried out in the example method.

Furthermore, the order of blocks is illustrative only and may change. Additional blocks may be added or fewer blocks may be utilized without departing from this disclosure.

At block 410, the second electronic device 120 receives the source signal from the source interface 1121 of the first electronic device 110 through the signal interface 1221.

The source interface 1121 of the first electronic device 110 may send the source signal. The signal interface 1221 may be coupled to the source interface 1121 through the connection device 130 to receive the source signal sent from the source interface 1121. The signal interface 1221 may include a plurality of signal pins P1, P2, . . . , and PN. In at least one implementation, the number N may be a positive integer greater than one.

The interface type of the source interface 1121 may be a first interface type included in a plurality of interface types, and the interface type of the signal interface 1221 may be a second interface type included in the plurality of interface types. Different interface types may have different interface structures. Thus, when the first interface type is different from the second interface type, the interface structure of the source interface 1121 may be different from the interface structure of the signal interface 1221. Therefore, the user may need to select a suitable connection device 130 according to the different interface structures of the source interface 1121 and the signal interface 1221 to enable two ends of the connection device 130 to couple to the source interface 1121 and the signal interface 1221 having different interface structures. For example, when the first interface type is HDMI and the second interface type is DP, two ends of the connection device 130 may have two different connectors being HDMI and DP, respectively. When the first interface type is identical to the second interface type, the interface structure of the source interface 1121 may be identical to the interface structure of the signal interface 1221. Therefore, the user may only need to select a suitable connection device 130 for connection according to the identical interface structures of the source interface 1121 and the signal interface 1221.

At block 420, the signal interface 1221 detects at least one specific signal level from a plurality of signal levels of the source signal by at least one first specific signal pin in the plurality of signal pins P1, P2, . . . , and PN.

The source interface 1121 may have a plurality of source pins, and each of the source pins of the source interface 1121 may send one of the plurality of signal levels to generate the source signal. Each of the plurality of signal pins P1, P2, . . . , and PN of the signal interface 1221 may correspond to one of a plurality of source pins of the source interface 1121. Thus, each of the plurality of signal pins P1, P2, . . . , and PN of the signal interface 1221 may receive one of the plurality of signal levels. When the first interface type is identical to the second interface type, the interface structure of the source interface 1121 may be identical to the interface structure of the signal interface 1221. Therefore, the number of the plurality of signal pins P1, P2, . . . , and PN of the signal interface 1221 may be identical to the number of the plurality of source pins of the source interface 1121, so that each of the plurality of signal pins P1, P2, . . . , and PN may be coupled to a corresponding one of the plurality of source pins of the source interface 1121.

When the first interface type is different from the second interface type, the interface structure of the source interface 1121 may be different from the interface structure of the signal interface 1221. Therefore, the number of the plurality of signal pins P1, P2, . . . , and PN of the signal interface 1221 may be different from the number of the plurality of source pins of the source interface 1121, so each of the plurality of signal pins P1, P2, . . . , and PN may not be coupled to one of the plurality of source pins of the source interface 1121. Therefore, there may be some redundant signal pins or source pins which are disconnected and remain inactive. For example, when the interface type of the source interface 1121 is DP and the interface type of the signal interface 1221 is HDMI, each of the 1st-19th source pins of the source interface 1121 may be coupled to a corresponding one of the 1st-19th source pins of the signal interface 1221. However, the 20th source pin of the source interface 1121 may not be coupled to the signal interface 1221, so that the 20th source pin may not supply power to the signal interface 1221. In the implementation, the power supply device of the second electronic device 120 may directly supply power to the signal interface 1221 of the HDMI interface.

At least one first specific signal pin included in the plurality of signal pins P1, P2, . . . , and PN may be coupled to the detecting circuit 1222. The detecting circuit 1222 may receive at least one specific signal level included in the plurality of signal levels from the at least one first specific signal pin and generate a detection result based on the detected at least one specific signal level. In at least one implementation, the detecting circuit 1222 may be a logic circuit. In at least one implementation, the detecting circuit 1222 may be a NOR logic circuit. When each of the at least one specific signal level detected by the detecting circuit 1222 is a ground level, the detecting circuit 1222 may output a high-level signal as the detection result. In at least one implementation, the detecting circuit 1222 may be an OR logic circuit. When each of the at least one specific signal level detected by the detecting circuit 1222 is the ground level, the detecting circuit 1222 may output a low-level signal as the detection result.

The detecting circuit 1222 may determine whether the first interface type is identical to the second interface type based on the detection result generated by the detection of the at least one specific signal level. The first interface type may be determined from a plurality of compatible interface types of the signal interface 1221. For example, each of the at least one first specific signal pin of the second interface type may be an interface pin for receiving the ground level. When each of the at least one specific signal level is the ground level, the first interface may be determined as being identical to the second interface type. Oppositely, when one of the at least one specific signal level is a high level, the first interface type may be determined as being different from the second interface type.

For example, the second interface type of the second interface module 122 may be selected from the plurality of interface types including HDMI and DP. Therefore, the at least one first specific signal pin may include the 13th, 14th, 16th, and the 19th pin in the plurality of signal pins. When the at least one specific signal level is the ground level, the source interface 1121 may be determined to be DP. When at least one of the at least one specific signal level is not the ground level, the source interface 1121 may be determined to be HDMI.

At block 430, according to the at least one specific signal level, the signal interface 1221 determines whether to switch at least one second specific signal pin of the plurality of signal pins to receive the source signal.

Each of at least one switch 12231, 12232, . . . and 1223n may be coupled to the detecting circuit 1222 and coupled to a corresponding one of the at least one second specific signal pin in the signal pins P1, P2, . . . , and PN to determine whether to switch the at least one second specific signal pin according to the detection result. In the implementation, the number N may be a positive integer greater than one.

The second interface module 122 may have a plurality of compatible interface types. The detecting circuit 1222 may be used to detect the first interface module 112 for determining which one of the plurality of compatible interface types is identical to the first interface type and output the detection result to the at least one switch 12231, 12232, . . . , and 1223n. Thus, the second interface module 122 may be switched according to a signal pin difference between the first interface type and the second interface type to cooperate with the first interface type of the first interface module 112 for performing the signal processing.

When the first interface type detected by the second interface module 122 is identical to the second interface type, the detecting circuit 1222 may output a first detection signal as the detection result. Then, the at least one switch 12231, 12232, . . . , and 1223n may allow the at least one second specific signal pin to remain unswitched according to the first detection signal for receiving the source signal. In addition, when the first interface type detected by the second interface module 122 is different from the second interface type, the detecting circuit 1222 may output a second detection signal as the detection result. Then, the at least one switch 12231, 12232, . . . , and 1223n may switch the at least one second specific signal pin according to the second detection signal for receiving the source signal.

For example, the plurality of interface types may include HDMI and DP. Therefore, the at least one second specific signal pin may be the 13th to 19th pins included in the plurality of signal pins. The at least one switch 12231, 12232, . . . , and 1223n may be preset to use the HDMI output terminal as the output terminal of the at least one switch 12231, 12232, . . . , and 1223n. When at least one of the at least one specific signal level is not the ground level, the at least one second specific signal pin may remain unswitched and output through the HDMI output terminal. When each of the at least one specific signal level is the ground level, the at least one second specific signal pin may be switched to output through the DP output terminal.

When the first interface module 112 has at least one switch, the second interface module 122 may send a control signal of the signal interface 1221 to the first interface module 112 for providing the detection result to the first interface module 112. The first interface module 112 may receive the control signal from the second interface module 122 to determine whether to use the at least one switch to switch at least one second specific signal pin of the source interface 1121. Therefore, when the control signal indicates that the second interface type may be different from the first interface type, the first interface module 112 may instruct the source interface 1121 to send the source signal according to the second interface type indicated by the control signal. In at least one implementation, the second interface module 122 may have a detecting circuit 1222 and no switch, so that the second interface module 122 may generate the detection result of the detecting circuit 1222 and send the control signal to the first interface module 112 for switching the operation mode of the first interface module 112.

In the present disclosure, due to the design of the detecting circuit 1222 and the at least one switch, the operation mode of the signal interface 1221 of the second electronic device 120 may not be restricted by its own interface structure. Thus, the signal interface 1221 may be able to receive the source signal from a different source interface having a different compatible interface type. In addition, the operation mode of the signal interface 1221 may be switched to be identical to the operation mode of the source interface 1121 based on the detection result of the detecting circuit 1222.

The disclosed implementations are to be considered in all respects as illustrative and not restrictive. It should also be understood that the present disclosure is not limited to the specific disclosed implementations but that many rearrangements, modifications, and substitutions are possible without departing from the scope of the present disclosure.

What is claimed is:

1. A method of processing a source signal received from a source device by an electronic device, the method comprising:
receiving the source signal from a source interface of the source device at a signal interface of the electronic device, the signal interface including a plurality of signal pins;
detecting at least one specific signal level in a plurality of signal levels of the source signal by at least one first specific signal pin in the plurality of signal pins; and
determining, based on the at least one specific signal level, whether to switch an operation mode of at least one second specific signal pin in the plurality of signal pins to receive the source signal.

2. The method according to claim 1, wherein:
an interface type of the source interface is a first one of a plurality of interface types, and
an interface type of the signal interface is a second one of the plurality of interface types.

3. The method according to claim 2, further comprising:
determining the first one of the plurality of interface types based on the at least one specific signal level;
switching the operation mode to receive the source signal when the first one of the plurality of interface types is different from the second one of the plurality of interface types; and
allowing the operation mode to remain unchanged to receive the source signal when the first one of the plurality of interface types is equal to the second one of the plurality of interface types.

4. The method according to claim 3, wherein:
the plurality of signal pins receives the source signal according to the second one of the plurality of interface types when the operation mode remains unchanged, and
the plurality of signal pins receives the source signal according to the first one of the plurality of interface types when the operation mode is switched.

5. The method according to claim 2, further comprising:
determining the first one of the plurality of interface types based on the at least one specific signal level; and
transmitting a control signal to the source device by the signal interface for indicating to the source interface to transmit the source signal according to the second one of the plurality of interface types when the first one of the plurality of interface types is different from the second one of the plurality of interface types.

6. The method according to claim 2, wherein:
each of the plurality of interface types has a pin distance, and
the pin distances of the plurality of interface types are identical to each other.

7. The method according to claim 2, wherein the plurality of interface types includes a High Definition Multimedia Interface (HDMI) and a display port interface (DisplayPort).

8. The method according to claim 7, further comprising:
determining the first one of the plurality of interface types is the DisplayPort when the at least one specific signal level is identical to a ground level; and
determining the first one of the plurality of interface types is the HDMI when one of the at least one specific signal level is different from the ground level.

9. The method according to claim 7, wherein:
the at least one first specific signal pin includes at least one of a thirteenth signal pin, a fourteenth signal pin, a sixteenth signal pin, and a nineteenth signal pin in the plurality of signal pins, and
the at least one second specific signal pin includes at least one of the at least one first specific signal pin, a fifteenth signal pin, a seventeenth signal pin, and an eighteenth signal pin.

10. The method according to claim 2, wherein:
the electronic device is coupled to the source device by a connection device including a first connection interface and a second connection interface,
an interface type of the first connection interface is identical to one of the first one and the second one of the plurality of interface types, and
an interface type of the second connection interface is identical to one of the first one and the second one of the plurality of interface types.

11. An electronic device for processing a source signal received from a source device, the electronic device comprising:
a signal interface comprising a plurality of signal pins, the signal interface being configured to receive the source signal from a source interface of the source device when the source device is coupled to the electronic device;
a detecting circuit coupled to at least one first specific signal pin of the plurality of signal pins, the detecting circuit being configured to detect at least one specific signal level in a plurality of signal levels of the source signal from the at least one first specific signal pin; and
at least one switch, each of the at least one switch being coupled to the detecting circuit and to one of at least one second specific signal pin of the plurality of signal pins to switch an operation mode of the at least one second specific signal pin based on the at least one specific signal level.

12. The electronic device according to claim 11, wherein:
an interface type of the source interface is a first one of a plurality of interface types, and
an interface type of the signal interface is a second one of the plurality of interface types.

13. The electronic device according to claim 12, wherein:
the operation mode is switched when the first one of the plurality of interface types determined based on the at least one specific signal level is different from the second one of the plurality of interface types, and
the operation mode remains unchanged when the first one of the plurality of interface types is equal to the second one of the plurality of interface types.

14. The electronic device according to claim 13, wherein:
the plurality of signal pins receives the source signal according to the second one of the plurality of interface types when the operation mode remains unchanged, and
the plurality of signal pins receives the source signal according to the first one of the plurality of interface types when the operation mode is switched.

15. The electronic device according to claim 12, wherein a control signal is transmitted to the source device by the signal interface for indicating to the source interface to transmit the source signal according to the second one of the plurality of interface types when the first one of the plurality of interface types determined based on the at least one specific signal level is different from the second one of the plurality of interface types.

16. The electronic device according to claim 12, wherein:
each of the plurality of interface types has a pin distance, and
the pin distances of the plurality of interface types are identical to each other.

17. The electronic device according to claim 12, wherein the plurality of interface types includes a High Definition Multimedia Interface (HDMI) and a display port interface (DisplayPort).

18. The electronic device according to claim 17, further comprising:
a power supply device coupled to the signal interface, the power supply device being configured to supply power to the signal interface for the signal interface to receive the source signal according to the HDMI when the first one of the plurality of interface types is the HDMI and the second one of the plurality of interface types is the DisplayPort.

19. The electronic device according to claim 17, wherein:
the first one of the plurality of interface types is determined as the DisplayPort when the at least one specific signal level is identical to a ground level, and
the first one of the plurality of interface types is determined as the HDMI when one of the at least one specific signal level is different from the ground level.

20. The electronic device according to claim 17, wherein:
the at least one first specific signal pin includes at least one of a thirteenth signal pin, a fourteenth signal pin, a sixteenth signal pin, and a nineteenth signal pin in the plurality of signal pins, and
the at least one second specific signal pin includes at least one of the at least one first specific signal pin, a fifteenth signal pin, a seventeenth signal pin, and an eighteenth signal pin.
